(19) United States
(12) Patent Application Publication
(10) Pub. No.: US 2009/0173576 A1
(43) Pub. Date: Jul. 9, 2009

(54) Lightweight movable work platform

(75) Inventor: L. Kenneth Rosenthal, Chino Hills, CA (US)

Correspondence Address: VENABLE LLP, P.O. BOX 34385, WASHINGTON, DC, 20043-9998, US

(73) Assignee: Merchant Media Corporation, Framington, MA (US)

(21) Appl. No.: 12/216,256

(22) Filed: Jul. 1, 2008

Related U.S. Application Data
(60) Provisional application No. 60/958,075, filed on Jul. 2, 2007.

(51) Int. Cl. E06C 7/16

(52) U.S. Cl. 182/116

(57) ABSTRACT

A lightweight movable work platform includes two pairs of side rails, each side rail having a top end and a bottom end, hinge means connecting each side rail in one of the pairs of side rails in the proximity of its top end to a corresponding side rail in the other of the pairs of side rails in the proximity of its top end, wheel means connecting each side rail in said pairs of side rails at its bottom end, a plurality of spreaders, each of which connects each side rail in the pairs of side rails between its top end and its bottom end, and drive means operable in the proximity of the bottom ends of the side rails for driving the wheel means. The hinge means is operable from a closed position in which the pairs of side rails are stowed together to an open position in which the bottom ends of such pairs of side rails are spread apart in a self-supporting, working position.

### CROSS-REFERENCE TO RELATED APPLICATIONS

This application claims priority under 35 U.S.C. § 119(e)(1) of provisional application U.S. Ser. No. 60/958,075 filed Jul. 2, 2007, the entirety of which is incorporated herein by reference.

### BACKGROUND OF THE INVENTION

1. Field of the Invention

Embodiments of the present invention are generally directed to platforms adapted to support human workers in their workplaces, and more specifically to lightweight movable work platforms that improve the speed and efficiency of such workers in performing their tasks.

2. Statement of the Prior Art

Work platforms such as ladders have been designed and produced in myriad forms and sizes for commercial, industrial, and consumer applications. See, e.g., U.S. Pat. No. 2,189,432 (Moore et al.) and U.S. Pat. No. 2,506,860 (Dimon). When a task requires the ladder to be relocated, it is often necessary for the worker to disembark from the ladder and either lift or roll it to the next location. Rolling ladders typically move when the worker is off the device, and may be locked in place at a selected location when the worker engages the device. Automatic propelled ladders and platforms have motors (both gas and electric) which do not require the worker to disembark or embark, but they are heavy, large, and expensive.

Another manually propelled ladder, described in published European Patent Application No. 0 269 936 A1, allowed the worker to remain at the ladder step while turning a handle at the ladder top, and thereby cause the ladder to move forward and back by the rotation of two large wheels at the back of the ladder. This device was heavy, could not turn right or left, required operation from the ladder top, and was bulky and not easily stored in the narrow area where most other ladders could fit, had only a very limited area for accessories or tools, possessed only three steps, could not be rolled to a new location if the user did not engage the top handle, and did not meet international safety standards such as 29 C.F.R. 1926 Subpart X, GS/TUV/BS EN131.

### SUMMARY OF THE INVENTION

It is an object of the invention to devise a manually propelled ladder which is lightweight, can move forward or backward and left and right (controlled and powered by a turning a crank, lever or the like, which is located either at the ladder apex or below), which will meet the OSHA and other government safety code regulations, and can collapse into a narrow area where other ladders of equal size are stored.

It is an object of the invention to devise a manually propelled ladder which may have different heights, slip resistant steps, attachments for multiple types of tools and construction materials, and attachments for platforms.

It is an object of the invention to transmit the mechanical turning and motion signals from the mechanisms atop and at different heights on the ladder to the propulsion and turning mechanisms at the base of the ladder.

It is an object of the invention in an alternative embodiment to devise a platform which most regular ladders can mount on and lock on, with said platform having means, when the user is on the ladder, that will move forward and backward and left and right via mechanical means.

It is an object of the invention in an alternative embodiment to manipulate the ladder and platform so the device performs as a manually propelled dolly.

It is an object of the invention in an alternative embodiment to have a seat attachment with user access to attachments which house tools, construction materials, and the like.

It is an object of the invention to employ wheels and the like which can engage hard floors, carpets, and floors with inclines.

### BRIEF DESCRIPTION OF THE DRAWINGS

The foregoing and other features of the invention will be apparent from the following, more particular description of exemplary embodiments of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts a lightweight movable work platform according to a first embodiment of the present invention;

FIG. 2 depicts an enlarged view of a crank element of a drive means used in the embodiment shown in FIG. 1, such crank element being depicted in its stowed position;

FIG. 3 depicts an enlarged view of the crank element of the drive means used in the embodiment shown in FIG. 1, such crank element being depicted in its engaged position;

FIG. 4 depicts the lightweight movable work platform moving from a first position towards a second position;

FIG. 5 depicts the lightweight movable work platform continuing to move from the first position towards the second position;

FIG. 6 depicts a drive shaft element of the drive means according to the first embodiment of the present invention;

FIG. 7 depicts an enlarged view of an upper portion of the drive shaft element shown in FIG. 6;

FIG. 8 depicts an enlarged view of a lower portion of the drive shaft element shown in FIG. 6;

FIG. 9 depicts a lightweight movable work platform according to a second embodiment of the present invention;

FIG. 10 depicts a top view of lightweight movable work platform shown in FIG. 9; and

FIG. 11 depicts an isolated underside view of a tray element of the lightweight movable work platform shown in FIG. 9.

### DETAILED DESCRIPTION OF EMBODIMENTS OF THE INVENTION

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the invention is not intended to be limited to the specific terminology so selected. A person skilled in the relevant art may recognize that other components and configurations may be used without parting from the spirit and scope of the invention. It is to be understood that each specific element includes all technical equivalents that operate in a similar manner to accomplish a similar purpose. The examples and embodiments described herein are non-limiting examples.

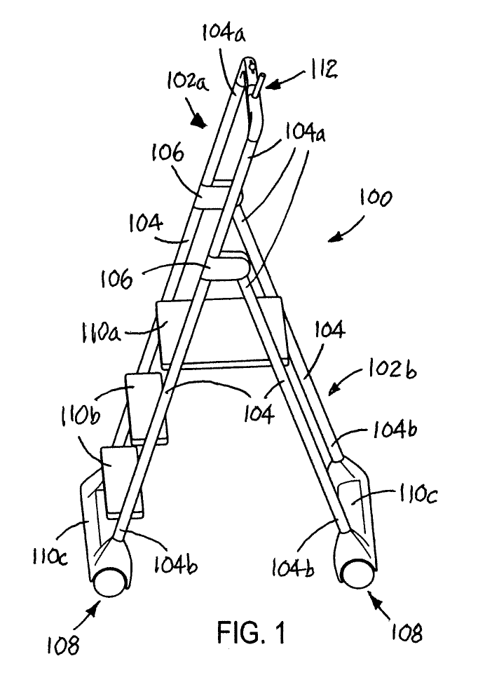

Referring now to FIG. 1, a lightweight movable work platform 100 according to a first embodiment of the present invention is shown. Platform 100 generally approximates the configuration of a step ladder. However, its general appearance and functionality as a step ladder should not be interpreted to unnecessarily limit platform 100 to that role.

Platform 100 generally comprises two pairs 102a, 102b of side rails 104, each of which has a top end 104a and a bottom end 104b. Hinge means 106 connects each said side rail 104 in one of said pairs 102a of side rails 104 in the proximity of its top end 104a to a corresponding side rail 104 in the other of said pairs 102b of side rails 104 in the proximity of its top end 104a Wheel means 108 connects each said side rail 104 in said pairs 102a, 102b of side rails 104 at its bottom end 104b. A plurality of spreaders 110a, 110b, 110c connects each said side rail 104 in said pairs 102a, 102b of side rails 104 between its top end 104a and its bottom end 104b. Drive means 112, operable in the proximity of the top end 104a of one of the side rails 104, may be used to drive said wheel means 108. The hinge means 106 is operable from a closed position (not shown) in which said pairs 102a, 102b of side rails 104 are stowed together to an open position in which said bottom ends 104b of said pairs 102a, 102b of side rails 104 are spread apart in a self-supporting, working position as shown in FIG. 1.

Hinge means 106 may suitably comprise a clevis (i.e., a usually U-shaped fastening device secured by a bolt or pin through holes in the end of the two arms) or shackle affixed to each of the side rails 104 in one pair 102a of side rails 104 to hingedly couple the top ends 104a of each of the side rails 104 in the other pair 102b of side rails 104.

Spreader 110a also functions as a working surface from which a worker may stand. It not only holds apart the side rails 104 of both pairs 102a, 102b of side rails 104, but also at the same time may be hingedly coupled to such side rails 104 to rotate between the open (i.e., working) and closed (i.e., stowed) positions of the platform 100. Spreader 110a may further comprise a spring-loaded and releasable locking mechanism to automatically lock the platform 100 in its working position as shown in FIG. 1. Spreaders 110b may comprise ladder rungs, cleats, or steps. Spreaders 110c also function as a housing for each of the wheel means 108. They not only hold apart the side rails 104 of both pairs 102a, 102b of side rails 104 in the proximity of their bottom ends 104b, but also at the same time may be used to protect the working parts of the wheel means 108 and the drive means 112.

In order to comply with OSHA and other government safety code regulations, platform 100 may be able to support at least four times its maximum intended load, except for extra-heavy-duty lightweight metal or plastic embodiments of platform 100, which must be able to sustain 3.3 times their maximum intended load. To the extent that the spreaders 110b are used as ladder rungs, cleats, or steps, they must be parallel, level, and uniformly spaced when the ladder is in position for use. Rungs may be suitably spaced between 10 and 14 inches apart, so shaped that a worker's foot may not slide off, and skid-resistant.

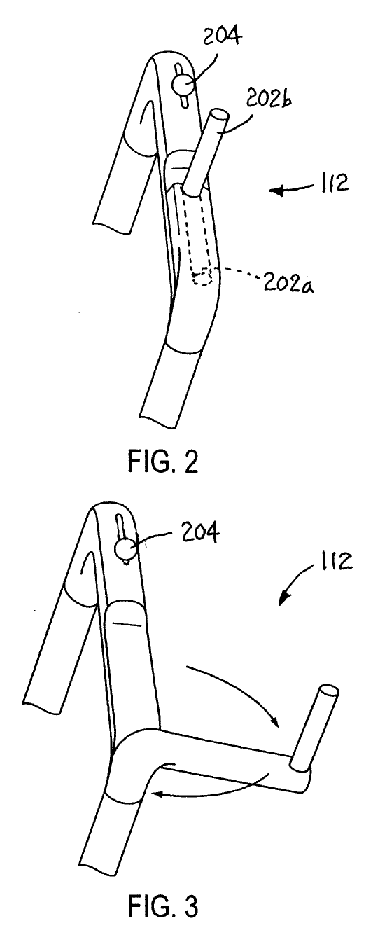

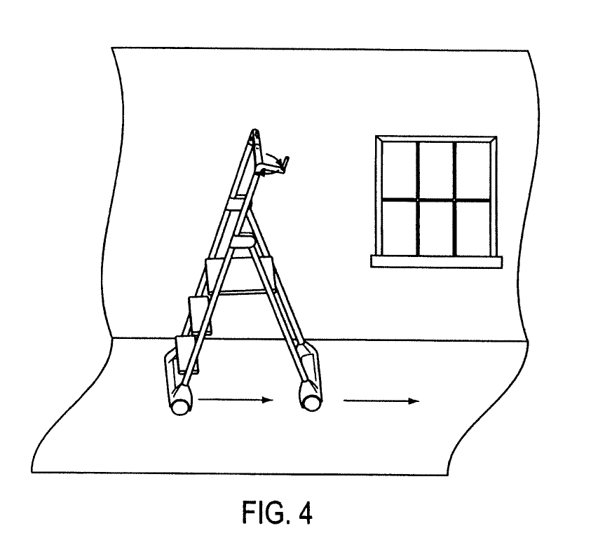

Referring now to FIGS. 2-5, details of the operation of the drive means 112 will now be described. A crank may be suitably formed by rotating a handle from a stowed position 202a to a deployed position 202b. From this position, the crank may be used to manually drive the wheel means 108, but not before a locking mechanism 204 is unlocked. Locking mechanism 204 suitably comprises a button, which is slidable in a groove from a “dead man's” position as shown in FIG. 2 to an operable position as shown in FIG. 3. In such a manner, locking mechanism 204 may be spring-loaded to automatically return to the “dead man's” position in the event the worker releases locking mechanism 204 during operation. Locking mechanism 204 may further include a third position at the other end of the groove in which the drive means 112 is positively locked when the platform 100 is not in use.

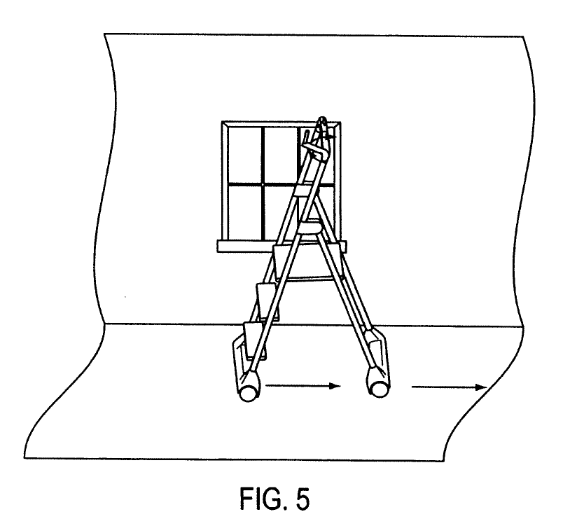

In use, however, the worker maintains the locking mechanism 204 in the operable position as shown in FIG. 3 while turning the crank. The crank may, thus, be rotated in a clockwise direction about a vertical axis to move the platform 100 in a forward direction as shown in FIG. 4. As long as the worker continues to rotate the crank in a clockwise direction as shown in FIG. 5, the platform 100 will move in a forward direction. Platform 100 is equally capable of moving in a backward direction as long as the worker maintains the locking mechanism 204 in the operable position as shown in FIG. 3 while turning the crank in a counter-clockwise direction.

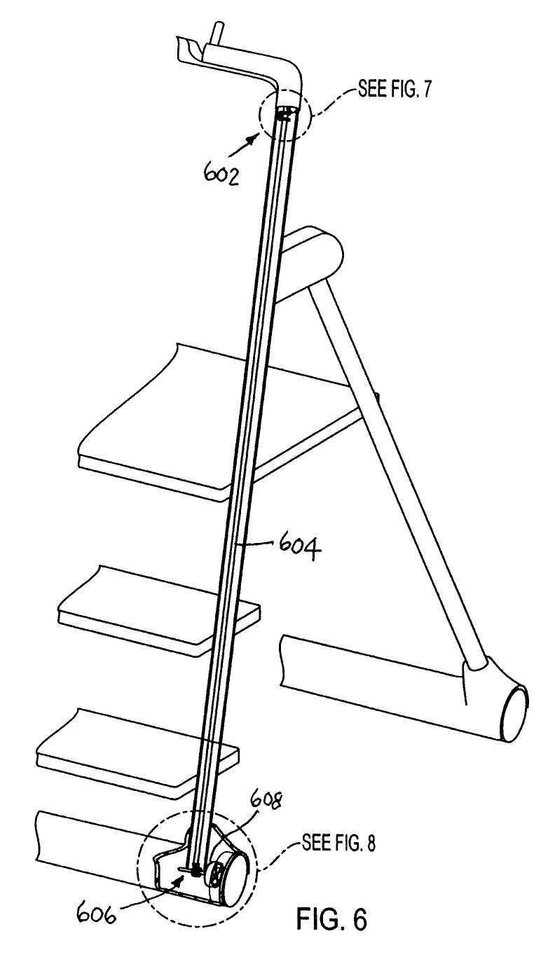

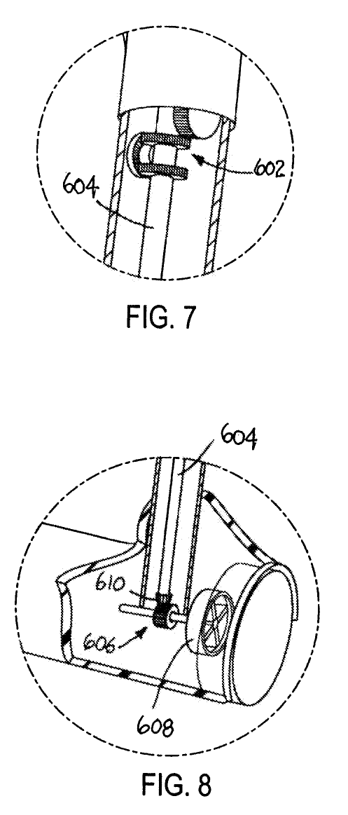

Referring now to FIGS. 6-8, even further details of the operation of the drive means 112 will now be described. Rotation of the crank by the worker may be translated to the wheel means 108 through first gear means 602, a drive shaft 604, second gear means 606, and a driving wheel 608.

As is well known, gears are generally used for one of four different reasons: (a) to reverse the direction of rotation; (b) to increase or decrease the speed of rotation; (c) to move rotational motion to a different axis; or (d) to keep the rotation of two axes synchronized. The upper of first gears means 602 may be comprised of a series of gears to absorb the weight of the platform 100 and worker and transfer it through the drive shaft 604. This allows for easy and smooth motion both forwards and backwards.

There are many other ways to use gears. For example, those of ordinary skill in the art will appreciate that one may use conical gears 610 to bend the axis of rotation in a gear train by 90 degrees. The most common place to find conical gears like this is in the differential of a rear-wheel-drive car. A differential bends the rotation of the engine 90 degrees to drive the rear wheels. The lower or second gear means 608 may be so comprised.

In operation, rotation of the crank by the worker may, thus, be translated to the wheel means 108 through first gear means 602, a drive shaft 604, second gear means 606, and a driving wheel 608. Other combinations of gears and transmission means are, of course, possible. For example, according to another embodiment of the present invention, the crank may be positioned in proximity to the top end of a side rail 104 and rotatable in a clockwise or counter-clockwise direction about a horizontal axis.

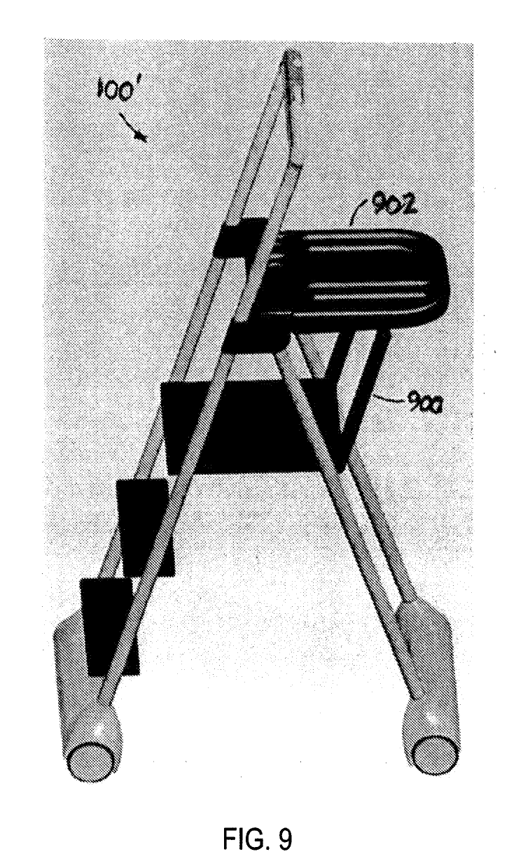

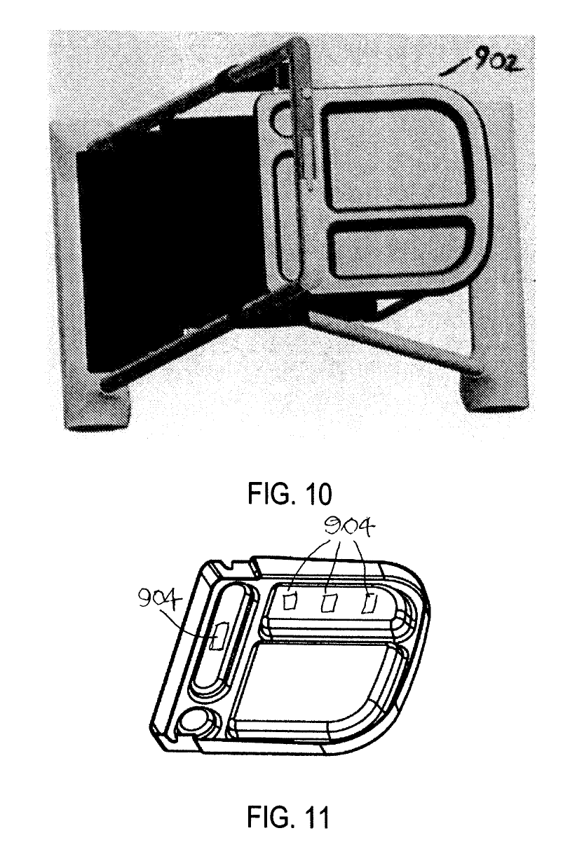

Referring now to FIGS. 9-11, a further embodiment of the present invention will now be described. The platform 100′ according to this embodiment includes support means 900 for safely attaching an accessory 902 to the platform 100′. Otherwise, platform 100′ may be similar in all respects to platform 100. As shown more clearly in FIGS. 10-11, the accessory 902 may comprise a tray with a plurality of compartments for accommodating one or more tools, work items (e.g., paint cans, paint brushes, rags, etc.), and the like, where they may be easily reach by a worker upon the platform 100′. The underside of accessory 902, as shown in FIG. 11, may further include one or more means for releasably holding the tools in place. For example, a plurality of magnets 904 may be attached to the underside of accessory 902 to releasably hold metallic tools in place.

While various embodiments of the present invention have been described above, it should be understood that they have been presented by way of example only, and not limitation. For example, support means 900 and the accessory 902 may be hingedly coupled to the platform 100′ to enable them to be folded into the stowed position along with the platform 100′. Support means 900 may also be adapted to hold a seat (not shown) upon which the worker may rest while performing tasks with the assistance of the platform 100′. Platforms 100, 100′ may further be adapted with support means 900 to accommodate other ladders (e.g., an extension ladder to convert the platform 100, 100′ into an extension trestle ladder). In such cases, the spacing between the side rails 104 may be 8-18 inches for the base, and 6-12 inches on the extension section.

In one embodiment according to the present invention, the height of the spreader 110a above the ground when locked into position may be about 70 cm. The lightweight material which may be used for the wheel means 108 is polypropylene (PP) wrapped with polyvinyl chloride (PVC), and the material which may be used for the side rails 104, spreaders 110c used as steps, etc. is a low carbon steel (e.g., Q195) wrapped with PVC.

Thus, the breadth and scope of the present invention should not be limited by any of the above-described exemplary embodiments, but should instead be defined only in accordance with the following claims and their equivalents.

1. A lightweight movable work platform, comprising:
two pairs of side rails, each said side rail having a top end and a bottom end;
hinge means connecting each said side rail in one of said pairs of side rails in the proximity of its top end to a corresponding side rail in the other of said pairs of side rails in the proximity of its top end;
wheel means connecting each said side rail in said pairs of side rails at its bottom end;
a plurality of spreaders, each of which connects each said side rail in said pairs of side rails between its top end and its bottom end; and
drive means operable in the proximity of the bottom ends of the side rails for driving said wheel means.
whereby said hinge means is operable from a closed position in which said pairs of side rails are stowed together to an open position in which said bottom ends of said pairs of side rails are spread apart in a self-supporting, working position.

2. The platform according to claim 1, wherein said hinge means comprises a clevis affixed to each of said side rails in one pair lof side rails and adapted to hingedly couple the top ends of each of the side rails in the other pair of side rails.

3. The platform according to claim 1, wherein one of said plurality of spreaders is adapted to function as a working surface from which a worker may stand.

4. The platform according to claim 3, wherein said one of said plurality of spreaders is adapted to hold apart the side rails of both pairs of side rails and at the same time hingedly coupled thereto to rotate between a working position and a stowed position.

5. The platform according to claim 4, further comprising a spring-loaded and releasable locking mechanism to automatically lock the platform in said working position.

6. The platform according to claim 1, wherein one or more of said plurality of spreaders comprise ladder rungs, cleats, or steps.

7. The platform according to claim 1, wherein another of said plurality of spreaders is adapted to function as a housing for each of said wheel means.

8. The platform according to claim 7, wherein said other of said plurality of spreaders is adapted to hold apart the side rails of both pairs of side rails in the proximity of their bottom ends while at the same time adapted to protect the working parts of the wheel means and the drive means.

9. The platform according to claim 1, wherein said drive means comprises a crank formed by rotating a handle from a stowed position to a deployed position in the proximity of the top ends of said side rails.

10. The platform according to claim 9, further comprising a locking mechanism adapted to disable said drive means.

11. The platform according to claim 10, wherein said locking mechanism further comprises a button operable in three positions including a first position in which the drive means is operable, and a second position in which the drive means is inoperable.

12. The platform according to claim 11, further comprising a third position in which said drive means is both inoperable and locked.

13. The platform according to claim 10, further comprising a spring-loaded mechanism to automatically return said button to said second position in the event the worker releases said button during operation of the drive means.

14. The platform according to claim 9, wherein said crank is adapted to be rotated in a selected direction about a vertical axis to move the platform.

15. The platform according to claim 14, wherein said crank is adapted to be rotated in a clockwise direction about a vertical axis to move the platform in a forward direction, and rotated in a counter-clockwise direction about a vertical axis to move the platform in a backward direction.

16. The platform according to claim 9, wherein said drive means further comprises:
first gear means operatively coupled to said crank;
a drive shaft operatively coupled at one end to said first gear means and adapted to translate rotation of said crank through said drive shaft;
second gear means operatively coupled to another end of said drive shaft and adapted to translated rotation of said drive shaft to said wheel means.

17. The platform according to claim 16, further comprising a driving wheel operatively coupled between said second gear means and said wheel means to propel the platform.

18. The platform according to claim 16, wherein said first gear means comprises a series of gears adapted to both absorb the weight of the platform and worker and transfer it through said drive shaft.

19. The platform according to claim 9, wherein said crank is positioned in proximity to the top end of a side rail and rotatable in a selected direction about a horizontal axis to move the platform.

20. A lightweight movable work platform, comprising:
two pairs of side rails, each said side rail having a top end and a bottom end;
hinge means connecting each said side rail in one of said pairs of side rails in the proximity of its top end to a corresponding side rail in the other of said pairs of side rails in the proximity of its top end;
wheel means connecting each said side rail in said pairs of side rails at its bottom end;
a plurality of spreaders, each of which connects each said side rail in said pairs of side rails between its top end and its bottom end;
drive means operable in the proximity of the bottom ends of the side rails for driving said wheel means; and
support means for safely attaching an accessory to the platform;
whereby said hinge means is operable from a closed position in which said pairs of side rails are stowed together to an open position in which said bottom ends of said pairs of side rails are spread apart in a self-supporting, working position.

21. The platform according to claim 20, wherein said accessory comprises a tray with a plurality of compartments for accommodating one or more tools, work items, and the like.

22. The platform according to claim 21, further comprising means for releasably holding said tools in place.

23. The platform according to claim 22, wherein said means for releasably holding said tools in place comprise a plurality of magnets attached to the underside of said tray to releasably hold a plurality of metallic tools in place.

24. The platform according to claim 20, wherein said accessory comprises a seat upon which the worker may rest while performing tasks with the assistance of the platform.

25. A lightweight movable work platform, comprising:
two pairs of side rails, each said side rail having a top end and a bottom end;
hinge means connecting each said side rail in one of said pairs of side rails in the proximity of its top end to a corresponding side rail in the other of said pairs of side rails in the proximity of its top end;
wheel means connecting each said side rail in said pairs of side rails at its bottom end;
a plurality of spreaders, each of which connects each said side rail in said pairs of side rails between its top end and its bottom end;
drive means operable in the proximity of the bottom ends of the side rails for driving said wheel means; and
support means for safely attaching an extension ladder to convert the platform into an extension trestle ladder;
whereby said hinge means is operable from a closed position in which said pairs of side rails are stowed together to an open position in which said bottom ends of said pairs of side rails are spread apart in a self-supporting, working position.
